(19) United States
(12) Patent Application Publication
(10) Pub. No.: US 2025/0097875 A1
(43) Pub. Date: Mar. 20, 2025

(54) PATH SWITCH BETWEEN RELAYS AND SECURITY PROCEDURES

(71) Applicant: Nokia Technologies Oy, Espoo (FI)

(72) Inventors: Jing PING, Chengdu (CN); Suresh P NAIR, Estero, FL (US); Ranganathan MAVUREDDI DHANASEKARAN, Munich (DE)

(21) Appl. No.: 18/966,295

(22) Filed: Dec. 3, 2024

Related U.S. Application Data
(63) Continuation of application No. PCT/CN2022/130443, filed on Nov. 7, 2022.

(51) Int. Cl. H04W 60/04; H04W 12/041; H04W 12/06; H04W 84/04

(52) U.S. Cl. CPC H04W 60/04; H04W 12/041; H04W 12/06; H04W 84/042

(57) ABSTRACT

Embodiments of the present disclosure relate to path switch between relays and security procedures. A terminal device obtains a selection policy for selecting a RSC from a plurality of RSCs, an RSC of the plurality of RSCs being associated with an indicator for indicating whether the RSC supports a CP security procedure or an UP security procedure. Based on determining that path switching from a source relay terminal device with a source RSC is triggered, the terminal device selects a target RSC based on the selection policy, a source indicator being associated with the source RSC, and a plurality of indicators being associated with the plurality of RSCs. The terminal device selects, for the path switching, a target relay terminal device based on the target RSC. As such, the service continuity after path switching between relays can be improved and delay or disruptions to the service can be avoided.

### TECHNICAL FIELD

Various example embodiments relate to the field of communication, and in particular, to devices, methods, apparatuses and computer readable storage media for path switch between relays and security procedures.

### BACKGROUND

User equipment (UE)-to-Network Relaying may relate to one or more relays, such as a Layer-3 UE-to-Network (U2N) relay and a Layer-2 UE-to-Network relay. The path switching between two indirect network communication paths for UE-to-Network Relaying may involve serval path switching scenarios. During the path switching, the service continuity and delay or disruptions to the service could be taken into consideration.

### SUMMARY

In general, example embodiments of the present disclosure provide devices, methods, apparatuses and computer readable storage media for path switch between relays security procedures.

In a first aspect, there is provided a remote terminal device. The remote terminal device comprises at least one processor, and at least one memory storing instructions. The instructions, when executed by the at least one processor, cause the remote terminal device at least to: obtain a selection policy for selecting a relay selection code (RSC) from a plurality of RSCs, an RSC of the plurality of RSCs being associated with an indicator for indicating whether the RSC supports a control plane (CP) security procedure or a user plane (UP) security procedure; based on determining that path switching from a source relay terminal device with a source RSC is triggered, select a target RSC based on the selection policy, a source indicator associated with the source RSC, and a plurality of indicators associated with the plurality of RSCs; and select, for the path switching, a target relay terminal device based on the target RSC.

In a second aspect, there is provided a remote terminal device. The remote terminal device comprises at least one processor, and at least one memory storing instructions. The instructions, when executed by the at least one processor, cause the remote terminal device at least to: obtain an authentication policy to be used by the remote terminal device to determine whether to trigger a proximity based services (ProSe) authentication procedure; and determine to trigger the ProSe authentication procedure at least based on the authentication policy.

In a third aspect, there is provided an authentication server function (AUSF) device. The AUSF device comprises at least one processor, and at least one memory storing instructions. The instructions, when executed by the at least one processor, cause the AUSF device at least to: generate a root key independent of a relay selection code (RSC), the root key being used to generate at least one proximity based services (ProSe) key for establishing a security link for a direct communication between a remote terminal device and a relay terminal device; and transmit, to a ProSe anchor function (PAnF) device, a ProSe key registration request without the RSC.

In a fourth aspect, there is provided a method. The method comprises: obtaining, at a remote terminal device, a selection policy for selecting a relay selection code (RSC) from a plurality of RSCs, an RSC of the plurality of RSCs being associated with an indicator for indicating whether the RSC supports a control plane (CP) security procedure or a user plane (UP) security procedure; based on determining that path switching from a source relay terminal device with a source RSC is triggered, selecting a target RSC based on the selection policy, a source indicator associated with the source RSC, and a plurality of indicators associated with the plurality of RSCs; and selecting, for the path switching, a target relay terminal device based on the target RSC.

In a fifth aspect, there is provided a method. The method comprises: obtaining, at a remote terminal device, an authentication policy to be used by the remote terminal device to determine whether to trigger a proximity based services (ProSe) authentication procedure; and determining to trigger the ProSe authentication procedure at least based on the authentication policy.

In a sixth aspect, there is provided a method. The method comprises: generating, at an authentication server function (AUSF) device, a root key independent of a relay selection code (RSC), the root key being used to generate at least one proximity based services (ProSe) key for establishing a security link for a direct communication between a remote terminal device and a relay terminal device; and transmitting, to a ProSe anchor function (PAnF) device, a ProSe key registration request without the RSC.

In a seventh aspect, there is provided an apparatus. The apparatus comprises means for performing the method according to the third, fourth or fifth aspect.

In an eighth aspect, there is provided a computer readable medium comprising program instructions. The instructions, when executed by an apparatus, cause the apparatus to perform the method according to the third, fourth or fifth aspect.

In a ninth aspect, there is provided a computer program comprising instructions, which, when executed by an apparatus, cause the apparatus at least to perform the method according to the third, fourth or fifth aspect.

In a tenth aspect, there is provided a device. The device comprises circuitries for performing: obtaining, at a remote terminal device, a selection policy for selecting a relay selection code (RSC) from a plurality of RSCs, an RSC of the plurality of RSCs being associated with an indicator for indicating whether the RSC supports a control plane (CP) security procedure or a user plane (UP) security procedure; based on determining that path switching from a source relay terminal device with a source RSC is triggered, selecting a target RSC based on the selection policy, a source indicator associated with the source RSC, and a plurality of indicators associated with the plurality of RSCs; and selecting, for the path switching, a target relay terminal device based on the target RSC.

In a eleventh aspect, there is provided a device. The device comprises circuitries for performing: obtaining, at a remote terminal device, an authentication policy to be used by the remote terminal device to determine whether to trigger a proximity based services (ProSe) authentication procedure; and determining to trigger the ProSe authentication procedure at least based on the authentication policy.

In a twelfth aspect, there is provided a device. The device comprises circuitries for performing: generating, at an authentication server function (AUSF) device, a root key independent of a relay selection code (RSC), the root key being used to generate at least one proximity based services (ProSe) key for establishing a security link for a direct communication between a remote terminal device and a relay terminal device; and transmitting, to a ProSe anchor function (PAnF) device, a ProSe key registration request without the RSC.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, in which:

FIG. 1A illustrates an example communication environment in which embodiments of the present disclosure can be implemented;

FIG. 1B illustrates a PC5 security establishment procedure for 5G ProSe UE-to-Network relay communication over User Plane;

FIG. 1C illustrates a PC5 security establishment procedure for 5G ProSe UE-to-Network relay communication over Control Plane;

FIG. 2 illustrates an example flowchart showing an example process of RSC selections in accordance with some embodiments of the present disclosure;

FIG. 3 illustrates an example signaling chart showing an example process of RSC selections in accordance with some embodiments of the present disclosure;

FIG. 4 illustrates an example flowchart showing an example process of selecting an RSC and a relay based on a CP security indicator in accordance with some embodiments of the present disclosure;

FIG. 5 illustrates an example flowchart showing an example process for optimizing security procedures in accordance with some embodiments of the present disclosure;

FIG. 6 illustrates an example flowchart showing an example process for optimizing a CP security procedure in accordance with some embodiments of the present disclosure;

FIG. 7 illustrates an example signaling chart showing an UP security procedure optimized in accordance with some embodiments of the present disclosure;

FIG. 8 illustrates an example signaling chart showing a CP security procedure optimized in accordance with some embodiments of the present disclosure;

FIG. 9 shows a simplified block diagram of a device that is suitable for implementing example embodiments of the present disclosure; and

FIG. 10 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for ease of understanding and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communication between a terminal device and a network device in the communication network may be performed according to any suitable generation communication protocols, including, but not limited to, the fourth generation (4G), 4.5G, the future fifth generation (5G) new radio (NR) communication protocols, and/or any other protocols either currently known or to be developed in the future. Embodiments of the present disclosure may be applied in various communication systems. Given the rapid development in communication, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, UE, a subscriber station (SS), a portable subscriber station, a mobile station (MS), or an access terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the ment and/or or awireless network node(s), as appropriate. The user equipment apparatus may be the user equip control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

As described, the path switching between two indirect network communication paths for UE-to-Network Relaying may involve serval path switching scenarios, for example, Layer-3 UE-to-Network relay with Non-3GPP Inter Working Function (N3IWF) switching from/to Layer-3 UE-to-Network relay with N3IWF, Layer-3 UE-to-Network relay without N3IWF switching from/to Layer-3 UE-to-Network relay without N3IWF, Layer-3 UE-to-Network relay without N3IWF switching from/to Layer-3 UE-to-Network relay with N3IWF, Layer-2 UE-to-Network relay switching from/to Layer-2 UE-to-Network relay, Layer-2 UE-to-Network relay switching from/to Layer-3 UE-to-Network relay without N3IWF, and Layer-2 UE-to-Network relay switching from/to Layer-3 UE-to-Network relay with N3IWF.

It is understood that service continuity in different path switching cases can be achieved via application layer or session continuity. For service continuity during path switching, some aspects may be considered, for example, what are the triggers and criteria for path switching, how to select a UE-to-Network relay for path switching, identify the path switch procedure with service continuity consideration, identify how the service continuity is achieved for the solution in path switching.

For the triggers and criteria for path switching, the remote UE can path switch when the NG-RAN configured measurement thresholds and the criteria are satisfied or based on re-selection rules from application layer if any. Moreover, if multiple UE-to-Network relay UEs satisfy the relay re-selection criteria, the remote UE selects the target UE-to-Network relay for path switch based on the 5G ProSe policy or UE route selection policy (URSP) rules and the remote UE traffic handling with the consideration: the remote UE first selects a target relay UE which has same type as original relay UE, if this fails, then the remote UE re-evaluates the URSP or keeps evaluating the next route selection descriptor (RSD) of the selected URSP for target relay selection. In addition, the remote UE may use re-selection rules from the application layer (e.g. provided by an application server), the remote UE may discover that there are multiple UE-to-Network relay UEs that satisfy the re-selection rules and then selects the target UE-to-Network relay UE based on priority in the re-selection rules from the application layer.

For path switching case between two indirect Layer-3 UE-to-Network relay paths using N3IWF, using mobility and multihoming protocol (MOBIKE) may be selected for normative work.

However, when a remote UE switches to another relay UE, it may trigger new authentication and Prose Remote User Key (PRUK) generation, that may cost time and resource, therefore impact the service continuity and cause disruption to the service.

In some embodiments, the present disclosure proposes solutions to optimize relay selection procedure based on CP security indicator associated with RSC, further optimize security authentication procedure, and then improve the service continuity after path switching between ProSe L3 relays.

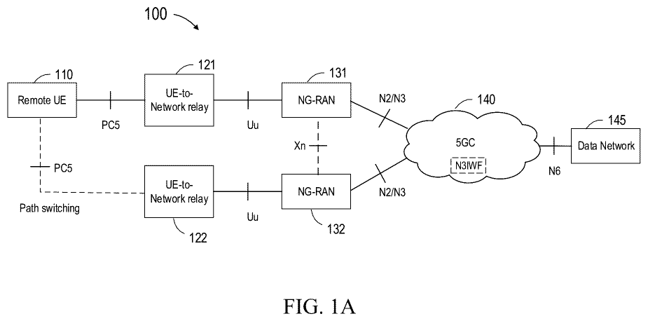

Principle and implementations of the present disclosure will be described in detail below with reference to FIGS. 1A to 10. FIG. 1A illustrates a schematic diagram of an example communication environment 100 in which embodiments of the present disclosure can be implemented. As shown in FIG. 1A, the communication environment 100 may involve a remote UE 110, UE-to-Network relays 121 and 122, NG-RANs 131 and 132, a 5G core (5GC) 140 and a data network 145. Further, it is to be understood that the number of the devices is only for ease of understanding without suggesting any limitations. The communication environment 100 may include any suitable number or type of the devices adapted for implementing embodiments of the present disclosure.

As shown in FIG. 1A, the remote UE 110 may connect to the UE-to-Network relay 121 via a PC5 interface and communicate with the data network 145 via the UE-to-Network relay or the UE-to-Network relay with N3IWF access. Moreover, the communication environment 100 may support service continuity for the remote UE 110 connected to the data network 145 via the 5G ProSe UE-to-Network relay 121 (i.e. indirect network communication path) switch to another indirect network communication path, e.g., via the 5G ProSe UE-to-Network relay 122.

In the context of the present disclosure, the term “UE-to-Network relay” may be interchangeably used with “5G ProSe Layer-3 UE-to-Network relay”, “5G ProSe UE-to-Network relay”, “U2N relay”, “relay UE” or “relay terminal device”. The term “remote UE” may be interchangeably used with “5G ProSe remote UE” or “relay terminal device”.

As known, ProSe may be services that can be provided by the third generation partnership project (3GPP) system based on UEs being in proximity to each other. The feature was introduced in LTE and evolved in 5G system (5GS). The 5GS enablers for ProSe include the following functions: 5G ProSe direct discovery; 5G ProSe direct communication; and 5G ProSe U2N relay.

PC5 is a reference point between ProSe-enabled UEs used for control and user planes for 5G ProSe direct discovery, 5G ProSe direct communication and 5G ProSe U2N relay.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G) or the future sixth generation (6G) wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

FIG. 1B illustrates a PC5 security establishment procedure 150 for 5G ProSe UE-to-Network relay communication over User Plane (UP). The procedure 150 may involve the remote UE 110, the UE-to-Network relay 121, a 5G direct discovery name management function (DDNMF) 151 of the remote UE 110, a ProSe key management function (PKMF) 152 of the remote UE 110, a 5G DDNMF 153 of the relay 121, a PKMF 154 of the relay 121, and a unified data management (UDM) (or a binding support function (BSF) or a home subscriber server (HSS)) 155 of the remote UE 110.

The 5G ProSe remote UE may be provisioned with the discovery security materials and Prose remote User Key (i.e., UP-PRUK) when it is in coverage. These security materials may be associated with an expiration time, after which they become invalid. If the UE does not have valid discovery security materials, the 5G ProSe remote UE may need to connect to the 5G ProSe key management function (PKMF) and obtain fresh ones to use the 5G ProSe UE-to-Network relay services.

The procedure is described for the scenario that the 5G PKMF of the 5G ProSe remote UE is different from the 5G PKMF of the 5G ProSe UE-to-Network relay. If both the 5G ProSe remote UE and the 5G ProSe UE-to-Network relay are served by a single 5G PKMF, the 5G PKMF may take the role of the 5G PKMF of the 5G ProSe remote UE and the 5G PKMF of the 5G ProSe UE-to-Network relay and the inter-5G PKMF message exchanges may be not needed.

As shown in FIG. 1B, at 160a, the 5G ProSe remote UE may get the 5G PKMF address from the 5G DDNMF of its HPLMN. Alternatively, the 5G ProSe remote UE may be provisioned with the 5G PKMF address by a policy control function (PCF). If the 5G ProSe remote UE is provisioned with the 5G PKMF address, the 5G ProSe remote UE may access the 5G PKMF directly without requesting it from the 5G DDNMF. In case that the 5G ProSe remote UE cannot access the 5G PKMF using the provisioned 5G PKMF address, the 5G ProSe remote UE may request the 5G PMKF address to the 5G DDNMF.

At 160b, the 5G ProSe remote UE may establish a secure connection with the 5G PKMF via PC8 reference point. Security for PC8 interface relies on Ua security if generic bootstrapping architecture (GBA) is used or a Ua* security if an authentication and key management for applications (AKMA) is used. The 5G PKMF of the 5G ProSe remote UE may check whether the 5G ProSe remote UE is authorized to receive UE-to-Network Relay service, and if the UE is authorized, the 5G PKMF of the 5G ProSe remote UE provides the discovery security materials to the 5G ProSe remote UE. If the 5G ProSe remote UE provides a list of visited networks, the 5G PKMF of the 5G ProSe remote UE may request the discovery security materials from the 5G PKMFs of the potential 5G ProSe UE-to-Network Relays from which the 5G ProSe remote UE gets the relay services. The 5G PKMF of the 5G ProSe UE-to-Network Relay may include the PC5 security policies to the 5G ProSe remote UE.

It is noted that the 5G PKMF may be locally configured with the UE's authorization information. Otherwise, the 5G PKMF may interact with the UDM of the UE to retrieve the UE's authorization information. In addition, the 5G ProSe remote UE may be provisioned by PCF with a list of the potential visited networks for the 5G ProSe UE-to-Network Relay service (which is identified by RSC).

At 160c, the 5G ProSe UE-to-Network Relay may get the 5G PKMF address from its home public land mobile network (HPLMN) in the same way as described in step 160a.

At 160d, the 5G ProSe UE-to-Network Relay may establish a secure connection with the 5G PKMF via PC8 reference point as in step 160b. The 5G PKMF of the 5G ProSe UE-to-Network Relay may check whether the 5G ProSe UE-to-Network Relay is authorized to provide 5G ProSe UE-to-Network Relay service, and if the UE is authorized, the 5G PKMF of the 5G ProSe UE-to-Network Relay may provide the discovery security materials to the 5G ProSe UE-to-Network Relay. The 5G PKMF of the 5G ProSe UE-to-Network Relay may include the PC5 security policies to the 5G ProSe UE-to-Network Relay.

At 161a, the 5G ProSe remote UE may send a PRUK Request message to its 5G PKMF. The message may indicate that the 5G ProSe remote UE is requesting an UP-PRUK from the 5G PKMF. If the 5G ProSe remote UE already has an UP-PRUK from this 5G PKMF, the message may also contain the UP-PRUK ID of the UP-PRUK.

An UP-PRUK identifier (ID) may take the form of either the network access identifier (NAI) format or the 64-bit string. If the UP-PRUK ID is in NAI format, i.e. username@realm, the realm part may include a HPLMN ID. The username part may include the 64-bit string.

At 161b, the 5G PKMF may check whether the 5G ProSe remote UE is authorized to receive UE-to-Network Relay services. This may be done by using the 5G ProSe remote UE's identity associated with the key used to establish the secure connection between the 5G ProSe remote UE and 5G PKMF in step 160b. If the 5G ProSe remote UE is authorized to receive the service, the 5G PKMF may send an UP-PRUK and UP-PRUK ID to the 5G ProSe remote UE. If an UP-PRUK and UP-PRUK ID are included, the 5G ProSe remote UE may store these and delete any previously stored ones for this 5G PKMF.

It is noted that steps 160a, 160b, 161a, 161b are performed when the 5G ProSe remote UE is in coverage.

At 162, the discovery procedure may be performed between the 5G ProSe remote UE and the 5G ProSe UE-to-Network Relay using the discovery parameters and discovery security material.

At 163, the 5G ProSe remote UE may send a direct communication request (DCR) that contains the UP-PRUK ID or a subscription concealed identifier (SUCI) if the remote UE does not have a valid UP-PRUK, RSC of the 5G ProSe UE-to-Network Relay service and a key for NR PC5 (KNRP) freshness parameter 1 to the 5G ProSe UE-to-Network Relay. If the UP-PRUK ID is not in NAI format, the DCR message may include the HPLMN ID of the 5G ProSe remote UE. The PC5 security establishment procedure between the 5G ProSe remote UE and the 5G ProSe UE-to-Network Relay including security parameters and security policy negotiation and protection of messages hereafter may follow the one-to-one security establishment.

At 164a, the 5G ProSe UE-to-Network Relay may send a Key Request message that contains the UP-PRUK ID or SUCI, RSC and KNRP freshness parameter 1 to its 5G PKMF. The Key Request message may also include the HPLMN ID of the 5G ProSe remote UE if it is included in the DCR.

At 164b, on receiving the Key Request message, the 5G PKMF of the 5G ProSe UE-to-Network Relay may check if the 5G ProSe UE-to-Network Relay is authorized to provide relay service to the 5G ProSe remote UE based on the 5G ProSe UE-to-Network Relay's identity associated with the key used to establish the secure PC8 connection and the received RSC.

It is noted that the 5G PKMF of the 5G ProSe UE-to-Network Relay may need to do the authorization of RSC based on its implementation. In addition, if the 5G ProSe UE-to-Network Relay's authorization information is not locally available, the 5G PKMF may request the authorization information from the UDM of the 5G ProSe UE-to-Network Relay (not shown) using Nudm_SDM Get service. If the 5G ProSe UE-to-Network Relay is authorized to provide the relay service based on ProSe Subscription data, the 5G PKMF of the 5G ProSe UE-to-Network Relay may send the Key Request with the UP-PRUK ID or the SUCI to the 5G PKMF of the 5G ProSe remote UE. The 5G PKMF of the 5G ProSe UE-to-Network Relay identifies the 5G PKMF address of the 5G ProSe remote UE based on the UP-PRUK ID or HPLMN ID or SUCI of the 5G ProSe remote UE if it is included in the Key Request message.

It is noted that the 5G PKMF of the 5G ProSe remote UE may need to do the authorization of RSC based on its implementation.

At 164c, on receiving the Key Request message from the 5G PKMF of the 5G ProSe UE-to-Network Relay, the 5G PKMF of the 5G ProSe remote UE may check if the 5G ProSe remote UE is authorized to use the relay service. The relay service authorization check may be based on the UP-PRUK ID and RSC included in the Key Request message or the SUPI of the remote UE and the RSC included in the Key Request message. If a SUCI is included in the Key Request message, the 5G PKMF of the 5G ProSe remote UE may request the UDM of the 5G ProSe remote UE to de-conceal the SUCI to gain the SUPI using Nudm UEIdentifier Deconceal service, and the UDM invokes a subscription identifier de-concealing function (SIDF) to de-conceal SUCI to gain a subscription permanent identifier (SUPI). If the 5G ProSe remote UE's authorization information is not locally available, the 5G PKMF may request the authorization information from the UDM of the 5G ProSe remote UE (not shown).

It is noted that Privacy issues may need to be considered while determining whether the SUPI is to be sent to the PKMF. For a privacy control, the UDM can authorize the PKMF based on its NF type or the service provider domain.

If a new UP-PRUK is required, the 5G PKMF may perform the one of the following procedures (as shown in the step 164c):

If the 5G PKMF of the 5G ProSe remote UE supports the Zpn interface to the BSF of the 5G ProSe remote UE, the 5G PKMF of the 5G ProSe remote UE may request a GBA push info (GPI) for the 5G ProSe remote UE from the BSF. When requesting the GPI, the 5G PKMF may include an UP-PRUK ID in the P-TID field. On receiving the GPI, the 5G PKMF may use Ks(_ext)_NAF as the UP-PRUK.

If the 5G PKMF of the 5G ProSe remote UE supports the SBI (Service based Interface) interface to the BSF of the 5G ProSe remote UE, the 5G PKMF may request the GPI via SBI interface. On receiving the GPI, the 5G PKMF may use Ks(_ext)_NAF as the UP-PRUK.

If the 5G PKMF of the 5G ProSe remote UE supports the PC4a interface to the HSS of the UE, then the 5G PKMF of 5G ProSe remote UE may request a GBA Authentication Vector (AV) for the 5G ProSe remote UE from the HSS. On receiving the AV, the 5G PKMF locally forms the GPI including an UP-PRUK ID in the P-TID field. The 5G PKMF may use Ks(_ext)_NAF as the UP-PRUK.

If the 5G PKMF of the 5G ProSe remote UE is co-located or integrated with BSF functionality and supports the SBI interface to the UDM/HSS of the 5G ProSe remote UE, the 5G PKMF may request the GBA AV via an SBI interface. On receiving the AV, the 5G PKMF locally forms the GPI including an UP-PRUK ID in the P-TID field. The 5G PKMF may use Ks(_ext)_NAF as the UP-PRUK.

It is noted that the GPI is supported only when GBA is used.

At 164d, the 5G PKMF of the 5G ProSe remote UE may generate KNRP freshness parameter 2 and derive KNRP using the UP-PRUK identified by UP-PRUK ID, RSC, KNRP freshness parameter 1 and KNRP freshness parameter 2. Then, the 5G PKMF of the 5G ProSe remote UE may send a Key Response message that contains KNRP and KNRP freshness parameter 2 to the 5G PKMF of the 5G ProSe UE-to-Network Relay. This message may include GPI if generated. The 5G PKMF of the 5G ProSe remote UE may also include the remote User ID of the 5G ProSe remote UE in the Key Response message to the 5G ProSe UE-to-Network Relay. The UP-PRUK ID may be used as a remote User ID in the present document.

At 164e, the 5G PKMF of the 5G ProSe UE-to-Network Relay may send the Key Response message to the 5G ProSe UE-to-Network Relay, which includes remote User ID, KNRP, KNRP freshness parameter 2, the GPI if used to calculate a fresh UP-PRUK to the UE-to-Network Relay.

At 165a, the 5G ProSe UE-to-Network Relay may derive the session key (KNRP-SESS) from KNRP and then derive the confidentiality key (NRPEK) (if applicable) and integrity key (NRPIK) based on the PC5 security policies. The 5G ProSe UE-to-Network Relay may store the remote User ID received in step 4d. The 5G ProSe UE-to-Network Relay may send a Direct Security Mode Command message to the 5G ProSe remote UE. This message may also include the KNRP Freshness Parameter 2.

At 165b, if the 5G ProSe remote UE receives the message containing the GPI, it processes the GPI. The 5G ProSe remote UE may derive the UP-PRUK and obtain the UP-PRUK ID from the GPI.

The 5G ProSe remote UE may derive KNRP from its UP-PRUK, RSC, KNRP Freshness Parameter 1 and the received KNRP Freshness Parameter 2. It may then derive the session key (KNRP-SESS) and the confidentiality key (NRPEK) (if applicable) and integrity key (NRPIK) based on the PC5 security policies in the same manner as the 5G ProSe UE-to-Network Relay and process the Direct Security Mode Command. Successful verification of the Direct Security Mode Command assures the 5G ProSe remote UE that the 5G ProSe UE-to-Network Relay is authorized to provide the relay service.

Handling of synchronization failure (for details of synchronization failures) when UE processes the authentication challenge in the GPI is performed. The 5G ProSe remote UE may send Direct Security Mode Failure message and include RAND and AUTS in the message. The 5G ProSe UE-to-Network Relay may send the key request message to the 5G PKMF of the 5G ProSe remote UE via the 5G PKMF of the 5G ProSe UE-to-Network Relay upon receiving the Direct Security Mode Failure message from the 5G ProSe remote UE. The key request message may include the HPLMN ID of the 5G ProSe remote UE, Relay Service Code and KNRP freshness parameter 1 together with the RAND and the AUTS received from the 5G ProSe remote UE. If the 5G PKMF of the 5G ProSe remote UE decides to retry GBA Push procedure, the 5G PKMF of the 5G ProSe remote UE may request GPI as described in step 164c.

At 165c, the 5G ProSe remote UE may respond with a Direct Security Mode Complete message to the 5G ProSe UE-to-Network Relay.

At 165d, on receiving the Direct Security Mode Complete message, the 5G ProSe UE-to-Network Relay may verify the Direct Security Mode Complete message. Successful verification of the Direct Security Mode Complete message assures the 5G ProSe UE-to-Network Relay that the 5G ProSe remote UE is authorized to get the relay service.

At 165e, after successful verification, the 5G ProSe UE-to-Network Relay responds a Direct Communication Accept message to the 5G ProSe remote UE to complete the PC5 connection establishment procedure.

At 166, the 5G ProSe remote UE and 5G ProSe UE-to-Network Relay continues the rest of procedure for the relay service over the secure PC5 link such as establishing a new protocol data unit (PDU) session or modifying an existing PDU session for relaying, if needed etc.

When the 5G ProSe Layer-3 UE-to-Network Relay sends a remote UE Report to the session management function (SMF), the 5G ProSe Layer-3 UE-to-Network Relay may include remote User ID received in step 164d. If the PRUK ID used as remote User ID is not in NAI format, the 5G ProSe Layer-3 UE-to-Network Relay may include the HPLMN ID of the 5G ProSe remote UE in the remote UE Report.

FIG. 1C illustrates a PC5 security establishment procedure 170 for 5G ProSe UE-to-Network relay communication over Control Plane (CP). The procedure 170 may involve the remote UE 110, the UE-to-Network relay 121, an access and mobility management function (AMF) 171 of the remote UE 110, an AMF 172 of the relay 121, an authentication server function (AUSF) 173 of the remote UE 110, the UDM 155 of the remote UE 110, and a ProSe anchor function (PAnF) 174 of the remote UE 110.

The procedure 170 describes the procedure for establishing a PC5 link between the 5G ProSe remote UE and the 5G ProSe UE-to-Network Relay. The procedure includes how the 5G ProSe remote UE is authenticated by the AUSF of the 5G ProSe remote UE via the 5G ProSe UE-to-Network Relay and the AMF of the 5G ProSe UE-to-Network Relay during 5G ProSe PC5 establishment. This mechanism can be used when the 5G ProSe remote UE is out of coverage.

At 180, the 5G ProSe remote UE and the 5G ProSe UE-to-Network Relay may be registered with the network. The 5G ProSe UE-to-Network Relay may be authenticated and authorized by the network to provide UE-to-Network Relay service. The 5G ProSe remote UE may be authenticated and authorized by the network to receive UE-to-Network Relay service. PC5 security policies are provisioned to the 5G ProSe remote UE and the 5G ProSe UE-to-Network Relay respectively during this authorization and information provisioning procedure.

At 181, the 5G ProSe remote UE or Relay UE may initiate discovery procedure using any of Model A or Model B method.

At 182, after the discovery of the 5G ProSe UE-to-Network Relay, the 5G ProSe remote UE may send a Direct Communication Request to the 5G ProSe UE-to-Network Relay for establishing secure PC5 unicast link. The 5G ProSe remote UE may include its security capabilities and PC5 signalling security policy in the DCR message. The message may also include Relay Service Code, Nonce 1.

If the 5G ProSe remote UE does not have a valid 5G Prose remote User Key (CP-PRUK), the 5G ProSe remote UE may include SUCI in the DCR to trigger 5G ProSe remote UE specific authentication and establish a CP-PRUK.

If the 5G ProSe remote UE already has a valid CP-P for Relay Service Code, the 5G ProSe remote UE may include associated the CP-PRUK ID in the DCR to indicate that the 5G ProSe remote UE wants to get relay connectivity using the CP-PRUK.

At 183, upon receiving the DCR message, the 5G ProSe UE-to-Network Relay may send the Relay Key Request to the AMF of the 5G ProSe UE-to-Network Relay, including SUCI or CP-PRUK ID, RSC and Nonce_1 received in the DCR message. The 5G ProSe UE-to-Network Relay may also include in the message a transaction identifier that identifies the 5G ProSe remote UE for the subsequent messages over 5G ProSe UE to Network Relay's NAS messages.

At 184, the AMF of the 5G ProSe UE-to-Network Relay may verify with the UDM whether the 5G ProSe UE-to-Network Relay is authorized to provide the UE-to-Network Relay service.

At 185, the AMF of the 5G ProSe UE-to-Network Relay may select an AUSF based on SUCI or CP-PRUK ID and forward the parameters received in Relay Key Request to the AUSF in Nausf_UEAuthentication_ProseAuthenticate Request message. The Nausf_UEAuthentication_ProseAuthenticate Request message may contain the 5G ProSe remote UE's SUCI or CP-PRUK ID, Relay Service Code, Nonce_1. If CP-PRUK ID is received from AMF of the 5G ProSe UE to Network Relay, the AUSF of the 5G ProSe remote temporarily may store Nonce_1 and UE skips steps 186-189. If the 5G ProSe remote UE's SUCI is received from AMF of the 5G ProSe UE-to-Network Relay, the AUSF of the 5G ProSe remote UE temporarily stores Nonce_1 and Relay Service Code and skips step 190.

At 186, the AUSF may initiate a 5G ProSe remote UE specific authentication using the ProSe specific parameters received (i.e. RSC, etc.).

The AUSF of the 5G ProSe remote UE may retrieve the Authentication Vectors and the Routing Indicator of the 5G ProSe remote UE from the UDM via Nudm_UEAuthentication_GetProseAv Request message. Upon reception of the Nudm_UEAuthentication_GetProSeAv Request, the UDM may invoke SIDF de-conceal SUCI to gain SUPI before UDM can process the request. The UDM checks whether the UE is authorized to use a ProSe UE-to-Network Relay service based on authorization information in UE's Subscription data. If the UE is authorized, the UDM may choose the extensible authentication protocol authentication and key agreement (EAP-AKA)′ authentication method based on the received Nudm_UEAuthentication_GetProseAv Request.

At 187a, the AUSF may temporarily store XRES, Routing indicator and SUPI. The AUSF of the 5G ProSe remote UE may trigger authentication of the 5G ProSe remote UE based on EAP-AKA′. The AUSF of the 5G ProSe remote UE may generate the EAP-Request/AKA′-Challenge message and send EAP-Request/AKA′-Challenge message to the AMF of the 5G ProSe UE-to-Network Relay in a Nausf_UEAuthentication_ProSeAuthenticate Response message.

At 187b, the AMF of the 5G ProSe UE-to-Network Relay may forward the Relay Authentication Request (including the EAP-Request/AKA′-Challenge) to the 5G ProSe UE-to-Network Relay over NAS message, including transaction identifier of the 5G ProSe remote UE in the message. The NAS message is protected using the NAS security context created for the 5G ProSe UE-to-Network Relay.

At 187c, based on the transaction identifier, the 5G ProSe UE-to-Network Relay may forwards the EAP-Request/AKA′-Challenge to the 5G ProSe remote UE over PC5 messages.

The USIM in the 5G ProSe remote UE may verify the freshness of the received values by checking whether AUTN can be accepted.

For EAP-AKA′, the USIM computes a response RES. The USIM may return RES, CK, IK to the ME. The ME may derive CK′ and IK′.

At 187d, the 5G ProSe remote UE may return EAP-Response/AKA′-Challenge to the 5G ProSe UE-to-Network Relay over PC5 messages.

At 187e, the 5G ProSe UE-to-Network Relay may forward the EAP-Response/AKA′-Challenge together with the transaction identifier of the 5G ProSe remote UE to the AMF of the 5G ProSe UE-to-Network Relay in a NAS message Relay Authentication Response.

At 187f, the AMF of the 5G ProSe UE-to-Network Relay may forward EAP-Response/AKA′-Challenge to the AUSF of the 5G ProSe remote UE via Nausf_UEAuthentication_ProSeAuthenticate Request.

The AUSF of the 5G ProSe remote UE may perform the UE authentication by verifying the received information.

For EAP-AKA′, the AUSF of the 5G ProSe remote UE and the 5G ProSe remote UE may exchange EAP-Request/AKA′-Notification and EAP-Response/AKA′-Notification messages via the AMF of the 5G ProSe UE-to-Network Relay and the 5G ProSe UE-to-Network Relay. After the exchanges, the AUSF of the 5G ProSe remote UE and the 5G ProSe remote UE may derive the KAUSF_P in the same way as KAUSF is derived.

At 188, on successful authentication, the AUSF of the 5G ProSe remote UE and the 5G ProSe remote UE may generate CP-PRUK and CP-PRUK ID.

The CP-PRUK ID may be in NAI format, i.e. username@realm. The username part includes the Routing Indicator from step 186 and the CP-PRUK ID, and the realm part includes Home Network Identifier.

At 189a, the AUSF of the 5G ProSe remote UE may select the PAnF based on CP-PRUK ID and send the SUPI, RSC, CP-PRUK and CP-PRUK ID in Npanf_ProseKey_Register Request message to the PAnF.

At 189b, the PAnF may store the Prose context info (i.e. SUPI, RSC, CP-PRUK, CP-PRUK ID) for the 5G ProSe remote UE and send Npanf_ProseKey_Register Response message to the AUSF.

At 190a, the AUSF of the 5G ProSe remote UE may select the PAnF based on CP-PRUK ID and send received CP-PRUK ID and RSC in Npanf_ProseKey_get Request message.

At 190b, the PAnF may retrieve CP-PRUK based on the CP-PRUK ID and checks whether the 5G ProSe remote UE is authorized to use the UE-to-Network Relay service based on received RSC. If the 5G ProSe remote UE is authorized and the retrieved CP-PRUK is valid, the PAnF may send Npanf_ProseKey_get Response message with CP-PRUK to the AUSF.

At 191, the AUSF of the 5G ProSe remote UE may generate Nonce_2 and derive the KNR_ProSe key using CP-PRUK, Nonce_1 and Nonce_2 as defined in clause A.4.

At 192, the AUSF of the 5G ProSe remote UE may send the KNR_ProSe, Nonce_2 in Nausf_UEAuthentication_ProseAuthenticate Response message to the 5G ProSe UE-to-Network Relay via the AMF of the 5G ProSe UE-to-Network Relay. EAP Success message may be included if step 187 is performed successfully. The AUSF of the 5G ProSe remote UE may also include the CP-PRUK ID in the message.

At 193, when receiving a KNR_ProSe from the AUSF of the 5G ProSe remote UE via the AMF of the 5G ProSe UE-to-Network Relay, the 5G ProSe UE-to-Network Relay may derive PC5 session key Krelay-sess and confidentiality key Krelay-enc (if applicable) and integrity key Krelay-int from KNR_ProSe. KNR_ProSe ID and Krelay-sess ID are established in the same way as KNRP ID and KNRP-sess ID. The 5GPRUK ID may be sent from the AMF of the 5G ProSe UE to-Network Relay to UE-to-Network Relay. The EAP Success message may be also sent from the AMF of the 5G ProSe UE to-Network Relay to UE-to-Network Relay if received from AUSF.

At 194, the 5G ProSe UE-to-Network Relay may send the received Nonce 2 and 5G ProSe remote UE's PC5 signalling security policy to the 5G ProSe remote UE in Direct Security mode command message, which is integrity protected using Krelay-int. EAP Success message may be included if received from the AMF of the 5G ProSe UE-to-Network Relay.

At 195, the 5G ProSe remote UE may generate the KNR_ProSe key to be used for remote access via the 5G ProSe UE to-Network Relay in the same way as defined in step 191. The 5G ProSe remote UE may derive PC5 session key Krelay-sess and confidentiality and integrity keys from KNR_ProSe in the same way as defined in step 193.

The 5G ProSe remote UE may verify the Direct Security Mode Command message. Successful verification of the Direct Security Mode Command message assures the 5G ProSe remote UE that the 5G ProSe UE-to-Network Relay is authorized to provide the relay service.

At 196, the 5G ProSe remote UE may send the Direct Security Mode Complete message containing its PC5 user plane security policies to the 5G ProSe UE-to-Network relay, which is protected by Krelay-int or/and Krelay-enc derived from Krelay-sess according to the negotiated PC5 signalling policies between the 5G ProSe remote UE and the 5G ProSe UE-to-Network Relay.

At 197, on receiving the Direct Security Mode Complete message, the 5G ProSe UE-to-Network Relay may verify the Direct Security Mode Complete message. Successful verification of the Direct Security Mode Complete message assures the 5G ProSe UE-to-Network Relay that the 5G ProSe remote UE is authorized to get the relay service.

After the successful verification of the Direct Security Mode complete message, the 5G ProSe UE-to-Network Relay may respond a Direct Communication Accept message to the 5G ProSe remote UE to finish the PC5 connection establishment procedures and store the CP-PRUK ID in the security context associated to the PC5 link with the 5G ProSe remote UE.

Further communication between the 5G ProSe remote UE and the Network may take place securely via the 5G ProSe UE to-Network Relay.

When the 5G ProSe Layer-3 UE-to-Network Relay sends a remote UE Report to the SMF, the 5G ProSe Layer-3 UE-to-Network Relay may include remote User ID (i.e. the 5GPRUK ID received in step 13) in the message.

As described, the remote UE may switch between different UE-to-Network (U2N) relays, including switching between U2N L3 relays.

In addition, security link can be built between the remote UE and U2N relay before the remote UE using the relay to transmit traffic. Security procedure may be performed to authenticate and authorize the UE to use the ProSe relay service, and generate keys to protect the link between the remote UE and U2N relay. 3GPP supports two modes of security procedures for authentication and key generation for L3 relay, one is UP based and another is CP based.

There are 6 possible use cases. In some cases, CP based re-authentication and key generation could be triggered, in some cases, UP based re-authentication and key generation could be triggered, in some cases, re-authentication will not be triggered and same PRUK could be used for deriving communication keys. Table 1 below shows path switching cases and whether re-authentication and key generation may be triggered for each case.

TABLE 1

| | |
|---|---|
| Case#1 | Initial relay UE-remote UE performed L3-UP and during path |
| | switch to new relay UE, performs L3-UP with same RSC- |
| | no re-authentication. |
| Case#2 | Initial relay UE-remote UE performed L3-UP and during path |
| | switch to new relay UE, perform L3-UP with different |
| | RSC-no re-authentication. |
| Case#3 | Initial relay UE-remote UE performed L3-UP and during path |
| | switch to new relay UE, performs L3-CP with different RSC- |
| | may re-authenticate if the security context for the RSC is not |
| | valid. |
| Case#4 | Initial relay UE-remote UE performed L3-CP and during path |
| | switch to new relay UE, performsL3-CP with same RSC-no |
| | re-authentication. |
| Case#5 | Initial relay UE-remote UE performed L3-CP and during path |
| | switch to new relay UE, L3-CP with different RSC-may |
| | re-authentication if the security context for the RSC is not valid. |
| Case#6 | Initial relay UE-remote UE performed L3-CP and during path |
| | switch to new relay UE, L3-UP with different RSC-may re- |
| | authentication if the security context for the RSC is not valid. |

As shown in the table above, when a remote UE switches to another relay UE, it may trigger new authentication and the PRUK generation, which may cost time and resource, therefore may cause service disruption and impact the service continuity.

In some embodiments, the present disclosure proposes solution to optimize relay selection procedure based on CP security indicator associated with RSC. For example, the remote UE (i.e., remote terminal device) may select a RSC with valid security context, e.g., select RSC with CP security indication if the corresponding CP-PRUK is valid, and include CP-PRUK ID in the DCR. In some embodiments, the remote UE may select a RSC without CP security indication if the corresponding UP-PRUK is valid, and include UP-PRUK ID in the DCR. In some embodiments, if both the CP-PRUK and UP-PRUK corresponding to the RSC are valid, the remote UE may select the RSC with same CP/UP mode to the current RSC, and include CP/UP-PRUK ID in the DCR. In some embodiments, if neither the CP-PRUK nor UP-PRUK corresponding to the RSC is valid, the remote UE may prioritize the RSC with same CP/UP mode to the current RSC, and include SUCI in the DCR. In some embodiments, the priority order could be pre-configured by HPLMN of the remote UE through authorization and provisioning procedure or UE implementation dependant.

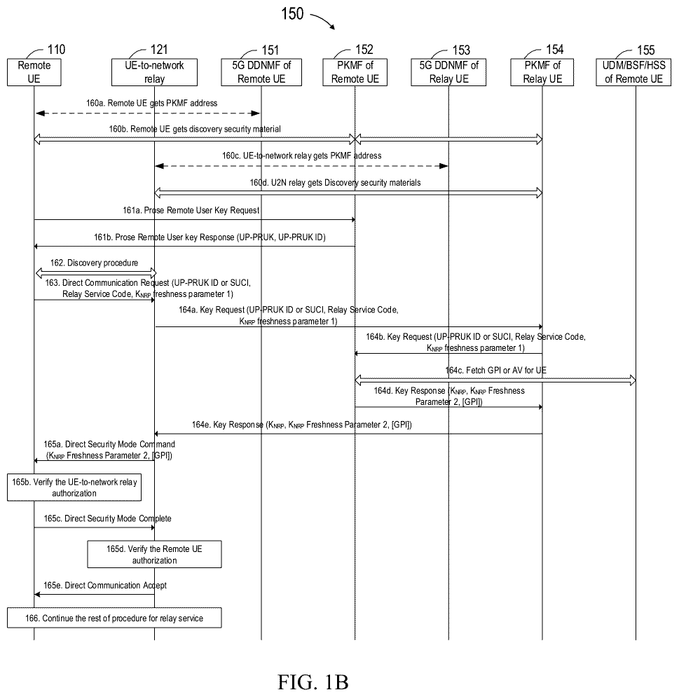

FIG. 2 illustrates an example flowchart showing an example process 200 of RSC selections in accordance with some embodiments of the present disclosure. For ease of understanding, the process 200 may involve the remote UE 110 (which can also be referred to as the remote terminal device) as shown in FIGS. 1A-1C.

At block 210, the remote UE 110 obtains a selection policy for selecting an RSC from a plurality of RSCs. An RSC of the plurality of RSCs is associated with an indicator (e.g., the CP security indicator) for indicating whether the RSC supports a CP security procedure or an UP security procedure.

At block 220, based on determining that path switching from a source relay terminal device with a source RSC is triggered, the remote UE 110 selects a target RSC based on the selection policy. A source indicator is associated with the source RSC, and a plurality of indicators is associated with the plurality of RSCs. At block 230, the remote UE 110 selects, for the path switching, a target relay UE (i.e., a target terminal device) based on the target RSC.

In some embodiments, the remote UE 110 may select the target relay terminal device with the target RSC that is the same as the source RSC. In some embodiments, the remote UE 110 may determine the plurality of RSCs and obtain the plurality of indicators. Moreover, the remote UE 110 may determine, based on the source RSC and the plurality of indicators, whether the source RSC and the plurality of RSCs support the CP security procedure or the UP security procedure.

In some embodiments, the remote UE 110 may select one of the plurality of RSCs for which the remote terminal device has a valid root key as the target RSC. In some embodiments, based on determining that the source RSC supports the CP security procedure, the remote UE 110 may select, as the target RSC, one of the plurality of RSCs for which the remote terminal device has the valid root key and supporting the CP security procedure.

Alternatively or in addition, based on determining that the source RSC supports the UP security procedure, the remote UE 110 may select, as the target RSC, one of the plurality of RSCs for which the remote terminal device has the valid root key and supporting the UP security procedure.

In some embodiments, the remote UE 110 may generate a DCR including an ID of the valid root key. The valid root key may be used to generate at least one security key for establishing a security link for a direct communication between the remote terminal device and the target relay terminal device.

In some embodiments, based on determining that the source RSC supports the CP security procedure, the remote UE 110 may select, as the target RSC, one of the at least one candidate RSC supporting the CP security procedure. Alternatively or in addition, based on determining that the source RSC supports the UP security procedure, the remote UE 110 may select, as the target RSC, one of the plurality of RSCs supporting the UP security procedure. Alternatively or in addition, the remote UE 110 may randomly select one of the plurality of RSCs as the target RSC.

In some embodiments, the remote UE 110 may generate a DCR including a SUCI used for triggering a ProSe authentication procedure of the remote terminal device.

In some embodiments, the selection policy may comprise a selection order based on the CP security procedure or the UP security procedure that the source RSC and the target RSC supported, and may further based on the authentication policy. Alternatively or in addition, the selection policy may comprise an authentication policy to be used by the remote terminal device to determine whether to trigger a ProSe authentication procedure. In some embodiments, the selection policy and/or authentication policy may be pre-configured by a HPLMN of the remote UE or based on an implementation of the remote UE.

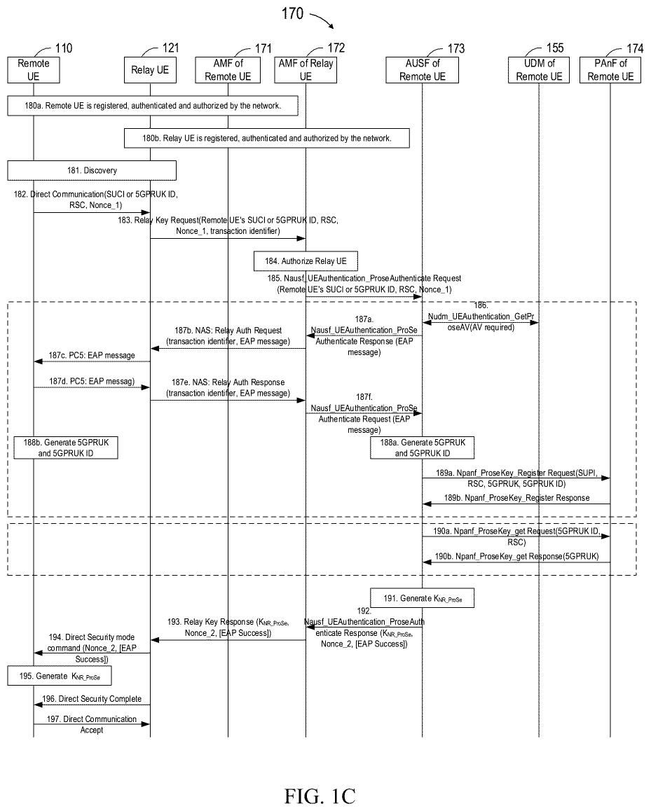

FIG. 3 illustrates an example signaling chart showing an example process 300 of RSC selections in accordance with some embodiments of the present disclosure. The example process 300 may involve the remote UE 110, the relays 121 and 122, the AMF 171 of the remote UE 110 or the PKMF 152 of the remote UE 110 (referred to as 201), the PKMF 154 of the relay 121, the PKMF 202 of the relay 122, a PCF 203 of the remote UE 110, and the AUSF 173 of the remote UE 110.

As shown in FIG. 3, at 310, the remote UE 110 may be provisioned with a CP indicator related RSC selection policy (e.g., a RSC selection priority order). Alternatively or in addition, the remote UE 110 may be provisioned with re-authentication policies, etc.

At 311, the remote UE 110 may selects relay UE 121 for communication.

At 312, path switching may be triggered from the relay UE 121, e.g., to relay UE 122.

At 313, the remote UE 110 may select RSC and corresponding relay based on a CP indicator associated with the RSCs. If the priority order related to the CP security indicator is preconfigured in the remote UE, the UE should follow the order required by the HPLMN to select RSC; otherwise it could be UE implementation dependent.

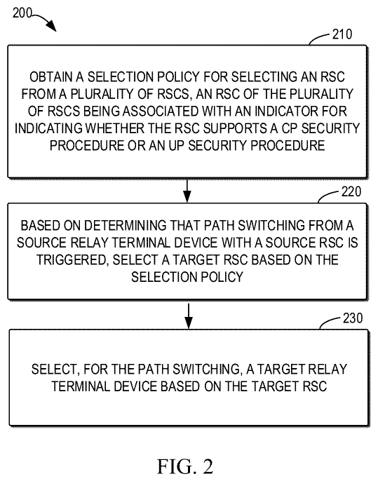

FIG. 4 shows an example 400 of RSC selections based on the CP indicator. As shown in FIG. 4, after path switching being triggered 401, the remote UE 110 may determine 402 whether there is a relay with the same RSC as the current relay (i.e., source relay). If a relay with the same RSC is found, the remote UE 110 may select 403 the relay as the target relay for path switching. If no relay with the same RSC is found, the remote UE 110 may select 404 candidate RSCs.

Then, the remote UE 110 may get 405 CP security indicators associated the source RSC and candidate RSCs to decide if the RSCs support CP or UP based security procedure. For example, if a CP security indicator exists, it may represent that the corresponding RSC supports the CP based security procedure; otherwise, if the CP or UP based security procedure absents, it may represent that the corresponding RSC supports the UP based security procedure. It is to be understood that the format of the CP security indicator is described only for ease of understanding without suggesting any limitation as to the scope of the disclosure, and the CP security indicator can be implemented in any suitable format.

The remote UE 110 may determine 406 whether there is a RSC with valid PRUK and supporting the same security procedure as the source RSC. If the RSC with valid PRUK and supporting the same security procedure is found, the remote UE 110 may select the RSC as the target RSC, use 408 the target RSC to select a target relay and include PRUK ID in the DCR. If no RSC with valid PRUK and supporting the same security procedure is found, the remote UE 110 may determine 407 whether there is a RSC with valid PRUK. If a RSC with valid PRUK is found, the remote UE 110 may select the RSC as the target RSC, use 408 the target RSC to select a target relay and include PRUK ID in the DCR.

If no RSC with valid PRUK is found, the remote UE 110 may determine 409 whether there is a RSC supporting the same security procedure as the source RSC. If the RSC supporting the same security procedure is found, the remote UE 110 may select the RSC as the target RSC, use 410 the target RSC to select a target relay and include a SUCI in the DCR. If no RSC supporting the same security procedure is found, the remote UE 110 may randomly select a RSC from the candidate RSCs or based on an implementation of the remote UE. Then, the remote UE 110 may select the randomly selected RSC as the target RSC, use 410 the target RSC to select a target relay and include a SUCI in the DCR.

It is to be understood that the flowchart 400 is given only for ease of understanding without suggesting any limitation, and the RSC selection policy of the disclosure can be implemented in any suitable order.

Return back to FIG. 3. At 314 (i.e., 314a-d), the procedures for direct communication as shown in FIGS. 1B and 1C can be followed. For brevity, procedures are not repeated here.

According to the above embodiments, the present disclosure proposes solutions to optimize relay selection procedure based on the CP security indicator associated with the RSC. With the solutions proposed, the service continuity after path switching between ProSe L3 relays can be improved and delay or disruptions to the service can be avoided.

According to other embodiments, the present disclosure further proposes solutions to optimize CP and UP security procedure to reduce re-authentication during path switching, while still keep the freshness of the PRUK during mobility of the remote UE. For example, for both UP and CP based procedure, ProSe re-authentication/authorization and PRUK re-generation may be triggered in the following cases. In case that the remote UE moves to a new PLMN, similar to primary authentication, the ProSe re-authentication/authorization and PRUK re-generation may be triggered by the remote UE. In case that the remote UE selects a relay in a new PLMN, the ProSe re-authentication/authorization and PRUK re-generation may be triggered by the remote UE. In case of expiration of the PRUK, subscription data change, etc., the HPLMN may trigger re-authentication. In some embodiments, the re-authentication may not be triggered, even for CP based procedure, when the remote UE switch to another RSC.

In some embodiments, a re-authentication policy is proposed by the present disclosure, and the same PRUK will be used for a remote UE regardless the change of RSC. The re-authentication could be determined based on re-authentication policy provisioned on the remote UE through authorization and provisioning procedure, or UE implementation dependant.

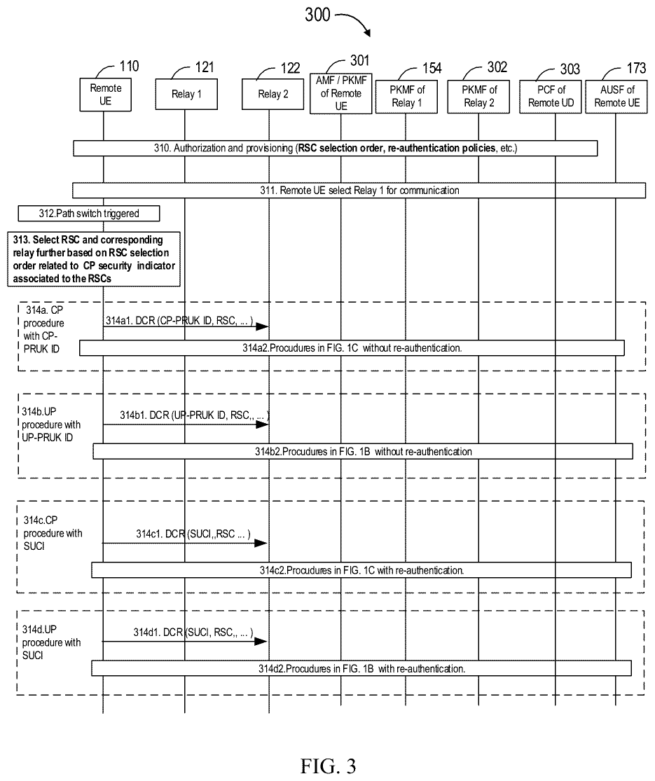

FIG. 5 illustrates an example flowchart showing an example process 500 for optimizing security procedures in accordance with some embodiments of the present disclosure. For ease of understanding, the process 500 may involve the remote UE 110 (which can also be referred to as the remote terminal device) as shown in FIGS. 1A-1C.

At block 510, the remote UE 110 obtains an authentication policy to be used by the remote terminal device to determine whether to trigger a ProSe authentication procedure. At block 520, the remote UE 110 determines to trigger the ProSe authentication procedure at least based on the authentication policy.

In some embodiments, the authentication policy may be based on mobility of the remote terminal device. In some embodiments, the remote UE 110 may determine to trigger the ProSe authentication procedure based on the remote terminal device moving to a new serving PLMN. In some embodiments, the remote UE 110 may determine to trigger the ProSe authentication procedure based on the remote terminal device selecting a relay terminal device in the new serving PLMN.

In some embodiments, the remote UE 110 may determine to trigger the ProSe authentication procedure based on a root key is invalid. The root key may be used to generate at least one security key for establishing a security link for the direct communication between the remote terminal device and the relay terminal device.

In some embodiments, the ProSe authentication procedure may comprise a CP security procedure. Moreover, the remote UE 110 may determine to trigger the ProSe authentication procedure based on the authentication policy regardless changing of a RSC, generation of the root key being independent of the RSC.

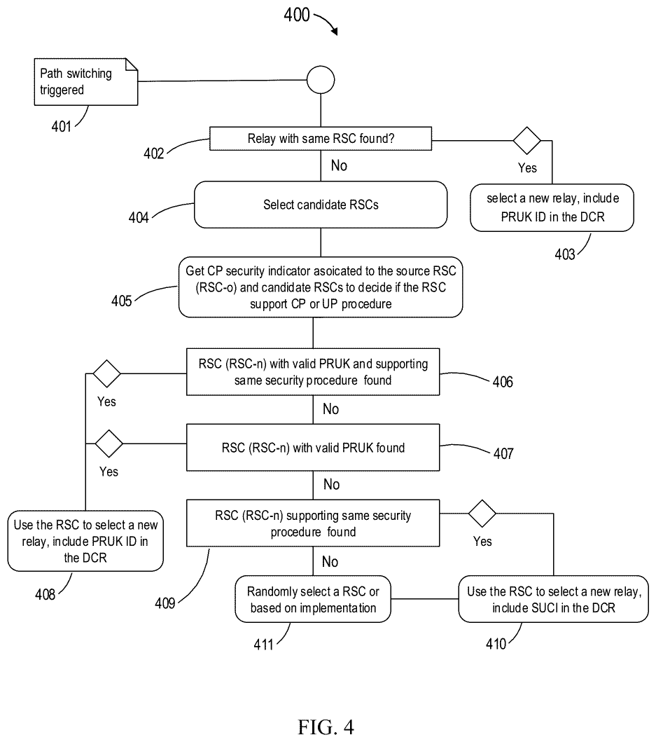

FIG. 6 illustrates an example flowchart showing an example process 600 for optimizing a CP security procedure in accordance with some embodiments of the present disclosure. For ease of understanding, the process 600 may involve the AUSF 173 as shown in FIG. 1C.

At block 610, the AUSF 173 generates a root key independent of an RSC. The root key is used to generate at least one ProSe key for establishing a security link for a direct communication between a remote terminal device and a relay terminal device. At block 620, the AUSF 173 transmits, to the PAnF device 174, a ProSe key registration request without the RSC.

In some embodiments, the AUSF 173 may transmit, to the PAnF device, a ProSe key get request to trigger a relay service authorization procedure of the remote terminal device based on the RSC. In some embodiments, the AUSF 173 may generate the at least ProSe security key based at least on the RSC. The at least ProSe security key may be RSC specific. In some embodiments, the root key may comprise a CP-PRUK.

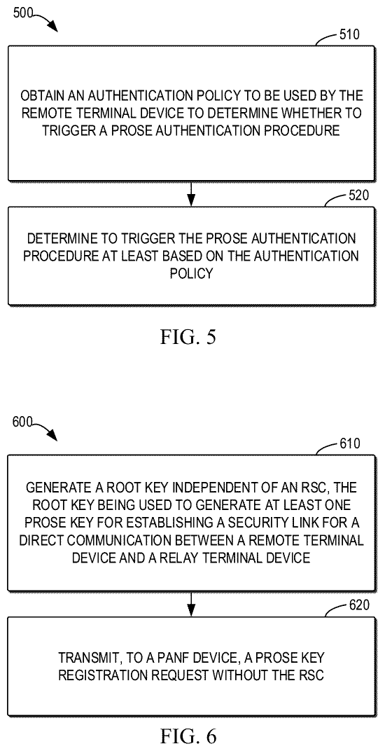

FIG. 7 illustrates an example signaling chart showing an UP security procedure 700 optimized in accordance with some embodiments of the present disclosure. The procedure 700 may involve the remote UE 110, the UE-to-Network relay 121, the 5G DDNMF 151 of the remote UE 110, the PKMF 152 of the remote UE 110, the 5G DDNMF 153 of the relay 121, the PKMF 154 of the relay 121, and the UDM (or the BSF or the HSS) 155 of the remote UE 110.

As shown in FIG. 7, at 710a, the remote UE 110 may be provisioned with re-authentication policies, etc. At 710b-710d, the remote UE 110 may follow the procedures as shown in FIG. 1B for PRUK request, then discovery and communication with a L3 U2N relay.

At 710e, the remote UE 110 may move to a new area. At 711, based on availability of UP PRUK and re-authentication policies pre-configured in the remote UE, or UE implementation, the remote UE 110 may trigger re-authentication. For example, the remote UE 110 may trigger re-authentication if the UE moves to a new serving PLMN, or the local PRUK is invalid (e.g., expired, corrupted, etc.).

At 712a, if the remote UE 110 is in coverage area, it may send PRUK request to HPLMN to get new key, which may trigger re-authentication/authorization and PRUK generation. At 712b, if the remote UE 110 is not in coverage area, it includes SUCI in next DCR request to a U2N relay, which may trigger re-authentication/authorization and PRUK generation.

The rest of procedures for relay service may be similar to those shown in FIG. 1B, which would not be repeated here.

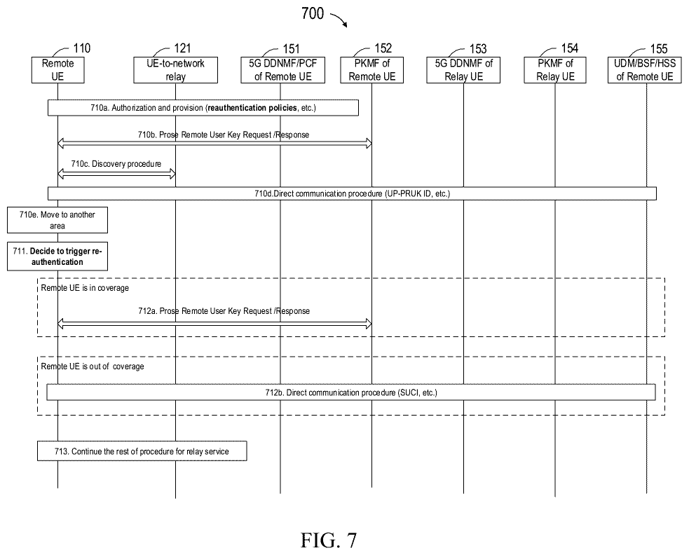

FIG. 8 illustrates an example signaling chart showing a CP security procedure 800 optimized in accordance with some embodiments of the present disclosure. The procedure 800 may involve the remote UE 110, the UE-to-Network relay 121, the AMF 171 of the remote UE 110, the AMF 172 of the relay 121, the AUSF 173 of the remote UE 110, the UDM 155 of the remote UE 110, and the PAnF 174 of the remote UE 110.

At 810, the 5G ProSe remote UE and the 5G ProSe UE-to-Network Relay may be registered with the network. The 5G ProSe UE-to-Network Relay may be authenticated and authorized by the network to provide UE-to-Network Relay service. The 5G ProSe remote UE may be authenticated and authorized by the network to receive UE-to-Network Relay service. PC5 security policies are provisioned to the 5G ProSe remote UE and the 5G ProSe UE-to-Network Relay respectively during this authorization and information provisioning procedure.

In addition, different from the procedure as shown in FIG. 1C, the re-authentication policies are provisioned to the 5G ProSe remote UE.

At 811, based on availability of CP-PRUK and re-authentication policies pre-configured in the remote UE, or UE implementation, the remote UE may trigger ProSe authentication/re-authentication. For example, the remote UE may trigger re-authentication if the UE moves to a new serving PLMN, or the local PRUK is invalid (e.g., expired, corrupted, etc.).

At 812, after the discovery of the 5G ProSe UE-to-Network Relay, the 5G ProSe remote UE may send a Direct Communication Request to the 5G ProSe UE-to-Network Relay for establishing secure PC5 unicast link. The 5G ProSe remote UE may include its security capabilities and PC5 signalling security policy in the DCR message. The message may also include Relay Service Code, Nonce_1.

If the 5G ProSe remote UE does not have a valid 5G Prose remote User Key (CP-PRUK) and re-authentication is needed, the 5G ProSe remote UE may include SUCI in the DCR to trigger 5G ProSe remote UE specific authentication and establish a CP-PRUK.

If the 5G ProSe remote UE already has a valid CP-P for Relay Service Code and re-authentication is not needed, the 5G ProSe remote UE may include associated the CP-PRUK ID in the DCR to indicate that the 5G ProSe remote UE wants to get relay connectivity using the CP-PRUK.

The steps 813 and 814 are similar to the steps 183 and 184 as shown in FIG. 1C, which would not be repeated here.

At 815, the AMF of the 5G ProSe UE-to-Network Relay may select an AUSF based on SUCI or CP-PRUK ID and forward the parameters received in Relay Key Request to the AUSF in Nausf_UEAuthentication_ProseAuthenticate Request message. The Nausf_UEAuthentication_ProseAuthenticate Request message may contain the 5G ProSe remote UE's SUCI or CP-PRUK ID, Relay Service Code, Nonce_1. If CP-PRUK ID is received from AMF of the 5G ProSe UE to Network Relay, the AUSF of the 5G ProSe remote temporarily may store Nonce_1 and UE skips steps 186-189. If the 5G ProSe remote UE's SUCI is received from AMF of the 5G ProSe UE-to-Network Relay, the AUSF of the 5G ProSe remote UE temporarily stores Nonce_1 and Relay Service Code. Different from the step 185 as shown in FIG. 1C, step 820 will not be skipped.

At 816, the AUSF may initiate a 5G ProSe remote UE specific authentication without using the ProSe specific parameters received (i.e. RSC, etc.).

The steps 817a-818 are similar to the steps 187a-188 as shown in FIG. 1C, which would not be repeated here.

At 819a, the AUSF of the 5G ProSe remote UE may select the PAnF based on CP-PRUK ID and send the SUPI, CP-PRUK and CP-PRUK ID in Npanf_ProseKey_Register Request message to the PAnF. Different from the step 189a as shown in FIG. 1C, the AUSF of the 5G ProSe remote UE may not send RSC in Npanf_ProseKey_Register Request message to the PAnF.

At 819b, the PAnF may store the Prose context info (i.e. SUPI, CP-PRUK, CP-PRUK ID) for the 5G ProSe remote UE and send Npanf_ProseKey_Register Response message to the AUSF. Different from the step 189b as shown in FIG. 1C, the AUSF of the 5G ProSe remote UE may store the Prose context info without RSC.

At 820a, the AUSF of the 5G ProSe remote UE may select the PAnF based on CP-PRUK ID and send received CP-PRUK ID and RSC in Npanf_ProseKey_get Request message.

At 820b, the PAnF may retrieve CP-PRUK based on the CP-PRUK ID and checks whether the 5G ProSe remote UE is authorized to use the UE-to-Network Relay service based on received RSC. If the 5G ProSe remote UE is authorized and the retrieved CP-PRUK is valid, the PAnF may send Npanf_ProseKey_get Response message with CP-PRUK to the AUSF.

At 821, The AUSF of the 5G ProSe remote UE may generate Nonce_2 and derive the K_{NR_ProSe} key using CP-PRUK, RSC, Nonce_1 and Nonce 2.

The steps 822-827 are similar to the steps 192-197 as shown in FIG. 1C, which would not be repeated here.

In some embodiments, an apparatus capable of performing any of the method 200 (for example, the remote UE 110) may comprise means for performing the respective steps of the method 200. The means may be implemented in any suitable form. For example, the means may be implemented in a circuitry or software module.

In some embodiments, the apparatus comprises: means for obtaining, at a remote terminal device, a selection policy for selecting a relay selection code (RSC) from a plurality of RSCs, an RSC of the plurality of RSCs being associated with an indicator for indicating whether the RSC supports a control plane (CP) security procedure or a user plane (UP) security procedure; means for based on determining that path switching from a source relay terminal device with a source RSC is triggered, selecting a target RSC based on the selection policy, a source indicator associated with the source RSC, and a plurality of indicators associated with the plurality of RSCs; and means for selecting, for the path switching, a target relay terminal device based on the target RSC.

In some embodiments, the means for selecting a target relay terminal device based on the target RSC comprises means for: selecting the target relay terminal device with the target RSC that is the same as the source RSC. In some embodiments, the apparatus further comprises means for: determining the plurality of RSCs; obtaining the plurality of indicators; and determining, based on the source RSC and the plurality of indicators, whether the source RSC and the plurality of RSCs support the CP security procedure or the UP security procedure.

In some embodiments, the means for selecting a target relay terminal device based on the target RSC comprises means for: selecting one of the plurality of RSCs for which the remote terminal device has a valid root key as the target RSC. In some embodiments, the means for selecting a target relay terminal device based on the target RSC comprises means for: based on determining that the source RSC supports the CP security procedure, select, as the target RSC, one of the plurality of RSCs for which the remote terminal device has the valid root key and supporting the CP security procedure.

In some embodiments, the means for selecting a target relay terminal device based on the target RSC comprises means for: based on determining that the source RSC supports the UP security procedure, select, as the target RSC, one of the plurality of RSCs for which the remote terminal device has the valid root key and supporting the UP security procedure.

In some embodiments, the apparatus further comprises means for: generating a direct communication request (DCR) including an identity (ID) of the valid root key, the valid root key being used to generate at least one security key for establishing a security link for a direct communication between the remote terminal device and the target relay terminal device.

In some embodiments, the apparatus further comprises: means for based on determining that the source RSC supports the CP security procedure, selecting, as the target RSC, one of the at least one candidate RSC supporting the CP security procedure; means for based on determining that the source RSC supports the UP security procedure, selecting, as the target RSC, one of the plurality of RSCs supporting the UP security procedure; or means for randomly selecting one of the plurality of RSCs as the target RSC.

In some embodiments, the apparatus further comprises means for: generating a DCR including a subscription concealed identifier (SUCI) used for triggering a proximity based services (ProSe) authentication procedure of the remote terminal device. In some embodiments, the selection policy comprises at least one of: a selection order based on the CP security procedure or the UP security procedure that the source RSC and the target RSC supported; or an authentication policy to be used by the remote terminal device to determine whether to trigger a proximity based services (ProSe) authentication procedure. In some embodiments, the selection policy is pre-configured by a home public land mobile network (HPLMN) of the remote terminal device or based on an implementation of the remote terminal device.

In some embodiments, the apparatus further comprises means for performing other steps in some embodiments of the method 200. In some embodiments, the means comprises at least one processor and at least one memory including computer program code, the at least one memory and computer program code configured to, with the at least one processor, cause the performance of the apparatus.

In some embodiments, an apparatus capable of performing any of the method 500 (for example, the remote UE 110) may comprise means for performing the respective steps of the method 500. The means may be implemented in any suitable form. For example, the means may be implemented in a circuitry or software module.

In some embodiments, the apparatus comprises: means for obtaining, at a remote terminal device, an authentication policy to be used by the remote terminal device to determine whether to trigger a proximity based services (ProSe) authentication procedure; and means for determining to trigger the ProSe authentication procedure at least based on the authentication policy.

In some embodiments, the authentication policy is based on mobility of the remote terminal device. In some embodiments, the means for determining to trigger the ProSe authentication procedure comprises means for: determining to trigger the ProSe authentication procedure based on the remote terminal device moving to a new serving public land mobile network (PLMN). In some embodiments, the means for determining to trigger the ProSe authentication procedure comprises means for: determining to trigger the ProSe authentication procedure based on the remote terminal device selecting a relay terminal device in the new serving PLMN.

In some embodiments, the means for determining to trigger the ProSe authentication procedure comprises means for: determining to trigger the ProSe authentication procedure based on a root key is invalid, wherein the root key is used to generate at least one security key for establishing a security link for the direct communication between the remote terminal device and the relay terminal device.

In some embodiments, the ProSe authentication procedure comprises a control plane (CP) security procedure. Moreover, the means for determining to trigger the ProSe authentication procedure at least based on the authentication policy comprises means for: determining to trigger the ProSe authentication procedure based on the authentication policy regardless changing of a RSC, generation of the root key being independent of the RSC.

In some embodiments, the apparatus further comprises means for performing other steps in some embodiments of the method 500. In some embodiments, the means comprises at least one processor and at least one memory including computer program code, the at least one memory and computer program code configured to, with the at least one processor, cause the performance of the apparatus.

In some embodiments, an apparatus capable of performing any of the method 600 (for example, the AUSF device 173) may comprise means for performing the respective steps of the method 600. The means may be implemented in any suitable form. For example, the means may be implemented in a circuitry or software module.

In some embodiments, the apparatus comprises: means for generating, at an authentication server function (AUSF) device, a root key independent of a relay selection code (RSC), the root key being used to generate at least one proximity based services (ProSe) key for establishing a security link for a direct communication between a remote terminal device and a relay terminal device; and means for transmitting, to a ProSe anchor function (PAnF) device, a ProSe key registration request without the RSC.

In some embodiments, the apparatus further comprises means for: transmitting, to the PAnF device, a ProSe key get request to trigger a relay service authorization procedure of the remote terminal device based on the RSC. In some embodiments, the apparatus further comprises means for: generating the at least ProSe security key based at least on the RSC, the at least ProSe security key being RSC specific. In some embodiments, the root key comprises a control plane ProSe remote user key (CP-PRUK).

In some embodiments, the apparatus further comprises means for performing other steps in some embodiments of the method 600. In some embodiments, the means comprises at least one processor and at least one memory including computer program code, the at least one memory and computer program code configured to, with the at least one processor, cause the performance of the apparatus.

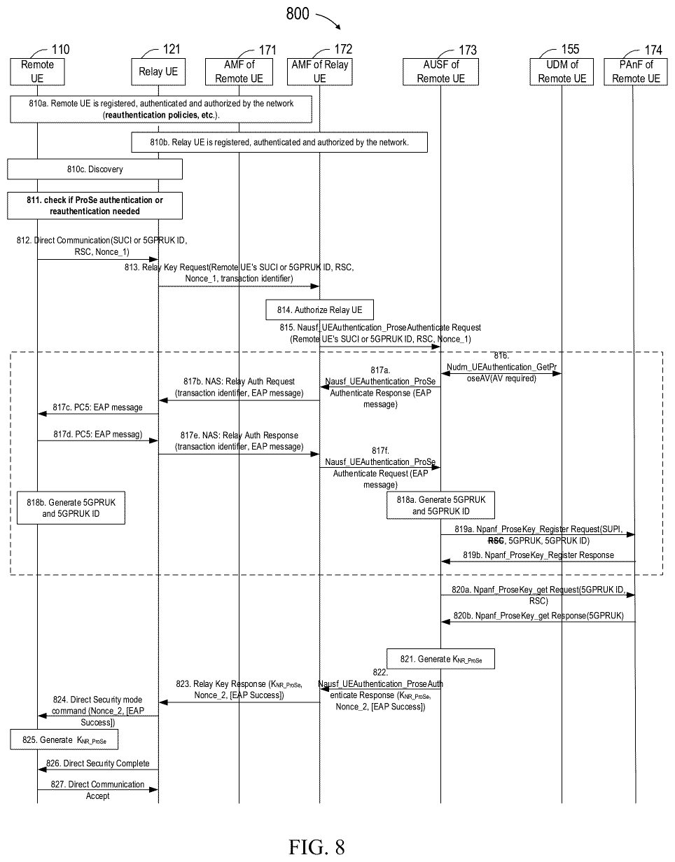

FIG. 9 is a simplified block diagram of a device 900 that is suitable for implementing embodiments of the present disclosure. The device 900 may be provided to implement the communication device, for example the remote UE 110 and the AUSF device 173. As shown, the device 900 includes one or more processors 910, one or more memories 920 coupled to the processor 910, and one or more communication modules (TX/RX) 940 coupled to the processor 910.

The one or more communication modules 940 are for bidirectional communications. The one or more communication modules 940 have at least one antenna to facilitate communication. The communication interface may represent any interface that is necessary for communication with other network elements.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The program 930 may be stored in the ROM 920. The processor 910 may perform any suitable actions and processing by loading the program 930 into the RAM 920.

The embodiments of the present disclosure may be implemented by means of the program 930 so that the device 900 may perform any process of the disclosure as discussed with reference to FIGS. 2 to 8. The embodiments of the present disclosure may also be implemented by hardware or by a combination of software and hardware.

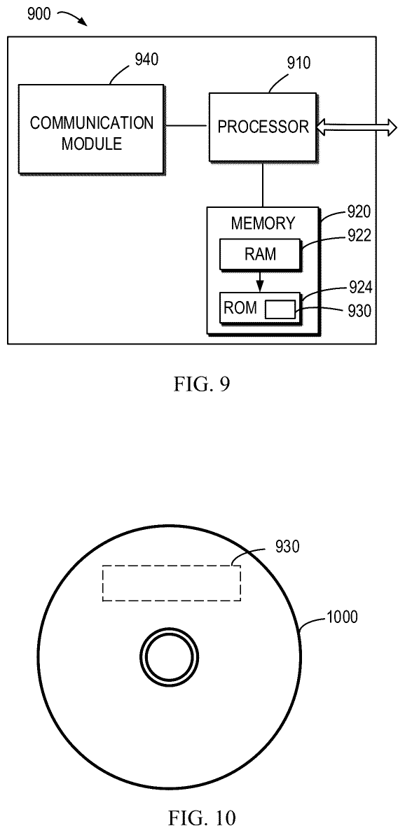

In some embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. The computer readable medium may include any types of tangible non-volatile storage, such as ROM, EPROM, a flash memory, a hard disk, CD, DVD, and the like. FIG. 10 shows an example of the computer readable medium 1000 in form of CD or DVD. The computer readable medium has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a transitory or non-transitory computer readable storage medium. The computer program product includes computer-executable instructions, such as those included in program modules, being executed in a device on a target real or virtual processor, to carry out the methods 200, 500 and 500 as described above with reference to FIGS. 2, 5 and 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. This program code may be provided to a processor or controller of a general purpose computer, special purpose computer, or other programmable data processing device, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the instructions or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A remote terminal device comprising:
at least one processor; and
at least one memory storing instructions that, when executed by the at least one processor, cause the remote terminal device at least to:
obtain a selection policy for selecting a relay selection code (RSC) from a plurality of RSCs, an RSC of the plurality of RSCs being associated with an indicator for indicating whether the RSC supports a control plane (CP) security procedure or a user plane (UP) security procedure;
based on determining that path switching from a source relay terminal device with a source RSC is triggered, select a target RSC based on the selection policy, a source indicator associated with the source RSC, and a plurality of indicators associated with the plurality of RSCs; and
select, for the path switching, a target relay terminal device based on the target RSC.

2. The remote terminal device of claim 1, wherein the remote terminal device is caused to select a target relay terminal device based on the target RSC by:
selecting the target relay terminal device with the target RSC that is the same as the source RSC.

3. The remote terminal device of claim 1 or 2, wherein the remote terminal device is further caused to:
determine the plurality of RSCs;
obtain the plurality of indicators; and
determine, based on the source RSC and the plurality of indicators, whether the source RSC and the plurality of RSCs support the CP security procedure or the UP security procedure.

4. The remote terminal device of claim 1 any of claims 1-3, wherein
the remote terminal device is caused to select the target RSC based on the selection policy by:
selecting one of the plurality of RSCs for which the remote terminal device has a valid root key as the target RSC.

5. The remote terminal device of claim 4, wherein the remote terminal device is further caused to select the target RSC based on the selection policy by:
based on determining that the source RSC supports the CP security procedure, select, as the target RSC, one of the plurality of RSCs for which the remote terminal device has the valid root key and supporting the CP security procedure.

6. The remote terminal device of claim 4, wherein the remote terminal device is further caused to select the target RSC based on the selection policy by:
based on determining that the source RSC supports the UP security procedure, select, as the target RSC, one of the plurality of RSCs for which the remote terminal device has the valid root key and supporting the UP security procedure.

7. The remote terminal device of claim 1 any of claims 1-6, wherein the remote terminal device is further caused to:
generate a direct communication request (DCR) including an identity (ID) of the valid root key, the valid root key being used to generate at least one security key for establishing a security link for a direct communication between the remote terminal device and the target relay terminal device.

8. The remote terminal device of claim 3, wherein the remote terminal device is further caused to at least one of:
based on determining that the source RSC supports the CP security procedure, select, as the target RSC, one of the at least one candidate RSC supporting the CP security procedure;
based on determining that the source RSC supports the UP security procedure, select, as the target RSC, one of the plurality of RSCs supporting the UP security procedure; or
randomly select one of the plurality of RSCs as the target RSC.

9. The remote terminal device of claim 8, wherein the remote terminal device is further caused to:
generate a DCR including a subscription concealed identifier (SUCI) used for triggering a proximity based services (ProSe) authentication procedure of the remote terminal device.

10. The remote terminal device of claim 1 any of claims 1-9, wherein the selection policy comprises at least one of:
a selection order based on the CP security procedure or the UP security procedure that the source RSC and the target RSC supported; or
an authentication policy to be used by the remote terminal device to determine whether to trigger a ProSe authentication procedure.

11. (canceled)

12. A remote terminal device comprising:
at least one processor; and
at least one memory storing instructions that, when executed by the at least one processor, cause the remote terminal device at least to:
obtain an authentication policy to be used by the remote terminal device to determine whether to trigger a proximity based services (ProSe) authentication procedure; and
determine to trigger the ProSe authentication procedure at least based on the authentication policy.

13. The remote terminal device of claim 12, wherein the authentication policy is based on mobility of the remote terminal device.

14. The remote terminal device of claim 12 or 13, wherein the remote terminal device is caused to determine to trigger the ProSe authentication procedure by:
determining to trigger the ProSe authentication procedure based on the remote terminal device moving to a new serving public land mobile network (PLMN).

15. The remote terminal device of claim 12-14, wherein the remote terminal device is caused to determine to trigger the ProSe authentication procedure by:
determining to trigger the ProSe authentication procedure based on the remote terminal device selecting a relay terminal device in the new serving PLMN.

16. The remote terminal device of claim 12 any of claims 12-15, wherein the remote terminal device is further caused to determine to trigger the ProSe authentication procedure by:
determining to trigger the ProSe authentication procedure based on a root key is invalid, wherein the root key is used to generate at least one security key for establishing a security link for the direct communication between the remote terminal device and the relay terminal device.

17. The remote terminal device of claim 12 any of claims 12-16, wherein the ProSe authentication procedure comprises a control plane (CP) security procedure, and the remote terminal device is caused to determine to trigger the ProSe authentication procedure at least based on the authentication policy by:
determining to trigger the ProSe authentication procedure based on the authentication policy regardless changing of a RSC, generation of the root key being independent of the RSC.

18. An authentication server function (AUSF) device comprising:
at least one processor; and
at least one memory storing instructions that, when executed by the at least one processor, cause the AUSF device at least to:
generate a root key independent of a relay selection code (RSC), the root key being used to generate at least one proximity based services (ProSe) key for establishing a security link for a direct communication between a remote terminal device and a relay terminal device; and
transmit, to a ProSe anchor function (PAnF) device, a ProSe key registration request without the RSC.

19. The AUSF device of claim 18, wherein AUSF device is further caused to:
transmit, to the PAnF device, a ProSe key get request to trigger a relay service authorization procedure of the remote terminal device based on the RSC.

20. The AUSF device of claim 18 or 19, wherein AUSF device is further caused to:
generate the at least ProSe security key based at least on the RSC, the at least ProSe security key being RSC specific.

21. The AUSF device of claim 18 any of claims 18-20, wherein the root key comprises a control plane ProSe remote user key (CP-PRUK).

22-28. (canceled)
